(19) United States
(12) Patent Application Publication
(10) Pub. No.: US 2017/0169630 A1
(43) Pub. Date: Jun. 15, 2017

(54) DIAGNOSIS CIRCUIT, SEMICONDUCTOR DEVICE, ON-VEHICLE ELECTRONIC CONTROL UNIT, AND DIAGNOSIS METHOD BY DIAGNOSIS CIRCUIT

(71) Applicant: Renesas Electronics Corporation, Tokyo (JP)

(72) Inventor: Tatsuya TATEBE, Tokyo (JP)

(21) Appl. No.: 15/365,534

(22) Filed: Nov. 30, 2016

(30) Foreign Application Priority Data
Dec. 10, 2015 (JP) 2015-240756

(51) Int. Cl. G07C 5/08; B60Q 9/00; G07C 5/02

(52) U.S. Cl. CPC G07C 5/0808; G07C 5/02; B60Q 9/00

(57) ABSTRACT

A diagnosis circuit includes a control unit configured to periodically switch one of a monitored voltage Vm corresponding to a power supply voltage VO1 when the power supply voltage VO1 is normal and a reference voltage for monitoring Vmref corresponding to a reference voltage Vref to one of first and second voltage values in such a way that a magnitude relationship between a voltage value of the monitored voltage Vm and a voltage value of the reference voltage for monitoring Vmref is periodically switched, a monitoring circuit configured to compare the monitored voltage Vm with the reference voltage for monitoring Vmref, and an evaluating circuit configured to evaluate as to whether or not the power supply voltage VO1 is normal and whether or not the monitoring circuit has a failure based on a monitoring result M1 by the monitoring circuit and information on the voltage value, which has been periodically switched by the control unit, of just one of the monitored voltage Vm and the reference voltage for monitoring Vmref.

### CROSS-REFERENCE TO RELATED APPLICATIONS

This application is based upon and claims the benefit of priority from Japanese patent application No. 2015-240756, filed on Dec. 10, 2015, the disclosure of which is incorporated herein in its entirety by reference.

### BACKGROUND

The present invention relates to a diagnosis circuit, a semiconductor device, an on-vehicle electronic control unit, and a diagnosis method by the diagnosis circuit, and to, for example, a diagnosis circuit, a semiconductor device, an on-vehicle electronic control unit, and a diagnosis method by the diagnosis circuit suitable for diagnosing a monitoring circuit that monitors a power supply voltage during normal operations.

An electronic control system driven by a power supply voltage is mounted on an automobile. For example, the electronic control system automatically controls an engine and a brake based on a result of detection by a sensor that detects a speed of the automobile. The electronic control system needs to accurately control the engine and the brake by being driven by a power supply voltage that is stably supplied. On the other hand, when the power supply voltage is not stably supplied, that is, when the power supply voltage is not normal, it is necessary to promptly execute processes such as switching a supplier of the power supply voltage and the like. By doing so, for example, malfunctions in the engine and the brake can be prevented.

Hence, a monitoring circuit that monitors as to whether or not the power supply voltage output by a power supply circuit is normal is mounted on the electronic control system. A diagnosis circuit that diagnoses as to whether or not the monitoring circuit has a failure is also mounted on the electronic control system.

A related technique is disclosed in Japanese Unexamined Patent Application Publication No. 2008-111786. A sensor circuit disclosed in Japanese Unexamined Patent Application Publication No. 2008-111786 includes a check signal input unit and a switch that switches between an input of a sensor internal state and an input of a check signal for each comparator included in an abnormality detection circuit. At the time of a primary check, a check signal that has a potential switched between a potential when the sensor internal state is normal and a potential when the sensor internal state is abnormal. In this way, an abnormality in the abnormality detection circuit can be detected, thereby preventing a false detection of an abnormality in the sensor circuit and preventing abnormality detection of the sensor circuit from being disabled.

### SUMMARY

In the configuration disclosed in Japanese Unexamined Patent Application Publication No. 2008-111786, a normal operation by the abnormality detection circuit cannot be performed at the same time as the diagnosis of an abnormality in the abnormality detection circuit. Accordingly, if there is an abnormality in the abnormality detection circuit during a normal operation, the abnormality cannot be detected until a diagnosis of the abnormality detection circuit is performed again. As a result, there may be a delay in detecting the abnormality in the abnormality detection circuit. Other problems of the related art and new features of the present invention will become apparent from the following descriptions of the specification and attached drawings.

In one aspect, a diagnosis circuit includes: a control unit configured to periodically switch one of a monitored voltage and a reference voltage for monitoring to one of a first voltage value and a second voltage value in such a way that a magnitude relationship between a voltage value of the monitored voltage and a voltage value of the reference voltage for monitoring is periodically switched, the monitored voltage corresponding to a power supply voltage when the power supply voltage output by a power supply circuit is normal based on a reference voltage, and the reference voltage for monitoring corresponding to the reference voltage; a comparison circuit configured to compare the monitored voltage with the reference voltage for monitoring; and an evaluating circuit configured to determine as to whether or not the power supply voltage is normal and whether or not the comparison circuit has a failure based on a result of the comparison by the comparison circuit and information on the voltage value, which has been periodically switched by the control unit, of just one of the monitored voltage and the reference voltage for monitoring.

In another aspect, a diagnosis method of a diagnosis circuit includes: periodically switching one of a monitored voltage and a reference voltage for monitoring to one of a first voltage value and a second voltage value in such a way that a magnitude relationship between a voltage value of the monitored voltage and a voltage value of the reference voltage for monitoring is periodically switched, the monitored voltage corresponding to a power supply voltage when the power supply voltage output by a power supply circuit is normal based on a reference voltage, and the reference voltage for monitoring corresponding to the reference voltage; comparing the monitored voltage with the reference voltage for monitoring by a comparison circuit; and evaluating as to whether or not the power supply voltage is normal and whether or not the comparison circuit has a failure based on a result of the comparison by the comparison circuit and information on the voltage value, which has been periodically switched, of just one of the monitored voltage and the reference voltage for monitoring.

According the above aspects, it is possible to provide a semiconductor device, an on-vehicle electronic control unit, and a diagnosis method by the diagnosis circuit that can diagnose a monitoring circuit for monitoring a power supply voltage during a normal operation.

### BRIEF DESCRIPTION OF THE DRAWINGS

The above and other aspects, advantages and features will be more apparent from the following description of certain embodiments taken in conjunction with the accompanying drawings, in which:

FIG. 1 is an external view of an automobile on which an electronic control system is mounted according to a first embodiment;

FIG. 2 is a block diagram showing a configuration example of the electronic control system mounted on the automobile shown in FIG. 1;

FIG. 3 is a drawing showing a specific configuration example of a part of a power supply IC provided in the electronic control system shown in FIG. 2;

FIG. 4 is a timing chart showing an operation of the power supply IC shown in FIG. 3;

FIG. 5 is a drawing showing a specific configuration example of the power supply IC provided in the electronic control system shown in FIG. 2;

FIG. 6 is a drawing showing a configuration example of a power supply IC according to a second embodiment;

FIG. 7 is a timing chart showing an operation of the power supply IC shown in FIG. 6;

FIG. 8 is a drawing showing a modified example of the power supply IC shown in FIG. 6;

FIG. 9 is a drawing showing a configuration example of a power supply IC according to a concept before the embodiments were conceived;

FIG. 10 is a timing chart showing a normal operation of the power supply IC shown in FIG. 9; and

FIG. 11 is a timing chart showing a failure diagnosis operation of the power supply IC shown in FIG. 9.

### DETAILED DESCRIPTION

Hereinafter, embodiments will be described with reference to the drawings. The drawings are in a simplified form, and the technical scope of the embodiments should not be interpreted to be limited to the drawings. The same elements are denoted by the same reference signs, and repeated descriptions are omitted.

The invention will be described by dividing it into a plurality of sections or embodiments whenever circumstances require it for convenience in the following embodiments. However, unless otherwise particularly specified, these sections or embodiments are not irrelevant to one another. One section or embodiment is related to modifications, applications, details, supplementary explanations, and the like of some or all of the other ones. When reference is made to the number of elements or the like (including the number of pieces, numerical values, quantity, range, etc.) in the following embodiments, the number thereof is not limited to a specific number and may be greater than or less than or equal to the specific number unless otherwise particularly specified and definitely limited to the specific number in principle.

Further, in the following embodiments, components (including operation steps, etc.) are not always essential unless otherwise particularly specified and considered to be definitely essential in principle. Similarly, when reference is made to the shapes, positional relations, and the like of the components or the like in the following embodiments, they will include ones, for example, substantially approximate or similar in their shapes or the like unless otherwise particularly specified and considered not to be definitely so in principle. This is similarly applied even to the above-described number or the like (including the number of pieces, numerical values, quantity, range, etc.).

### First Embodiment

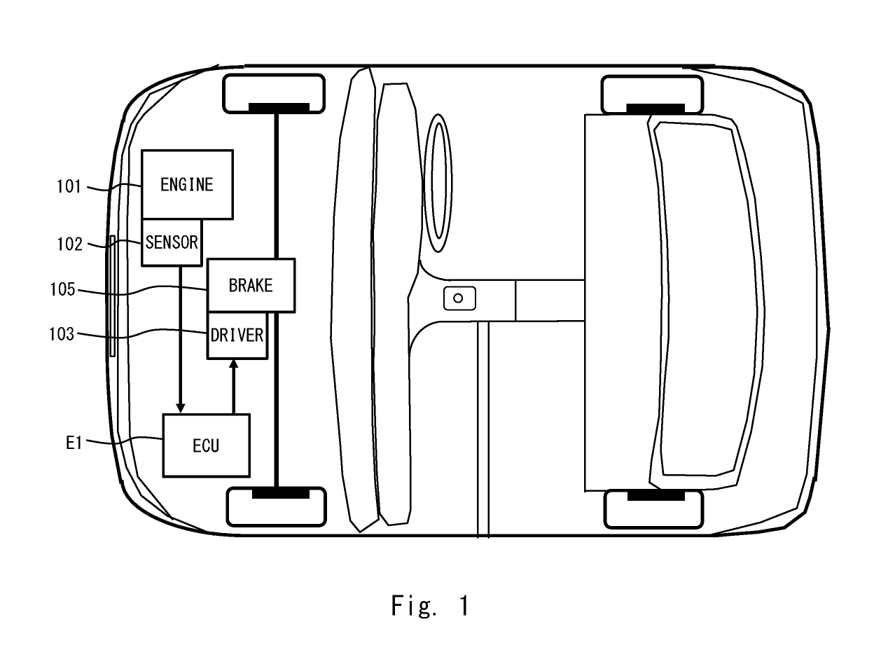

FIG. 1 is an external view of an automobile on which an electronic control system according to a first embodiment is mounted. Note that in FIG. 1, an example in which the electronic control system detects a vehicle speed from an engine speed of the automobile and automatically performs control on a brake based on a result of the detection will be described.

As shown in FIG. 1, an electronic control system SYS1 mounted on the automobile includes, for example, an electronic control unit El provided inside a cabin or an engine room of the automobile, a sensor 102 that detects the vehicle speed based on the engine speed of the engine 101, and a driver 103 that activates a brake 105 according to an instruction supplied by the electronic control unit El.

For example, when the electronic control unit El determines that the vehicle speed is too fast based on the result of the detection by the sensor 102, the electronic control unit El instructs the driver 103 to activate the brake 105 in order to reduce the vehicle speed.

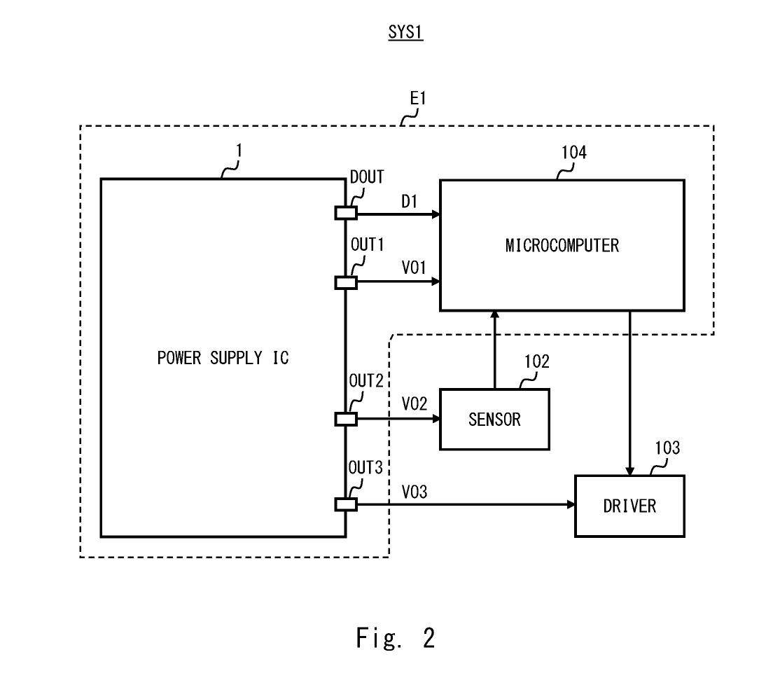

FIG. 2 is a block diagram showing a configuration example of the electronic control system SYS1 mounted on the automobile shown in FIG. 1. As shown in FIG. 2, the electronic control system SYS1 includes the electronic control unit El, the sensor 102, and the driver 103. The electronic control unit El includes a power supply IC (a semiconductor device) 1, and a microcomputer (a processing unit) 104.

The microcomputer 104 is driven by a power supply voltage VO1 supplied by the power supply IC1. When the microcomputer 104 determines that the vehicle speed is too fast based on the result of the detection by the sensor 102, the microcomputer 104 instructs the driver 103 to activate the brake 105 in order to reduce the vehicle speed. Note that the sensor 102 and the driver 103 are driven by power supply voltages VO2 and VO3, respectively, that are supplied by the power supply IC1.

The power supply IC1 supplies the power supply voltages VO1, VO2, and VO3 to the microcomputer 104, the sensor 102, and the driver 103, respectively. Further, the power supply IC1 includes a monitoring function that monitors as to whether or not the power supply voltages VO1 to VO3 are normal and a diagnosis function that diagnoses as to whether or not there is an abnormality in the monitoring function and then outputs an evaluation result D1. When the microcomputer 104 determines that the power supply voltages VO1 to VO3 are not normal based on the evaluation result D1 or determines that there is an abnormality in the monitoring function, the microcomputer 104 performs processes such as switching suppliers of the power supply voltages VO1 to VO3 and the like. The monitoring function and the diagnosis function of the power supply IC1 will be described later.

The power supply IC1 needs to accurately drive the microcomputer 104, the sensor 102, and the driver 103 by stably supplying the power supply voltages VO1 to VO3. On the other hand, when the power supply IC1 cannot stably supply the power supply voltages VO1 to VO3, i.e., when the power supply voltages VO1 to VO3 are not normal, the microcomputer 104 needs to promptly perform the processes such as switching the suppliers of the power supply voltages VO1 to VO3. By doing so, for example, malfunctions of the brake 105 can be prevented.

### (Previous Examination by the Inventor)

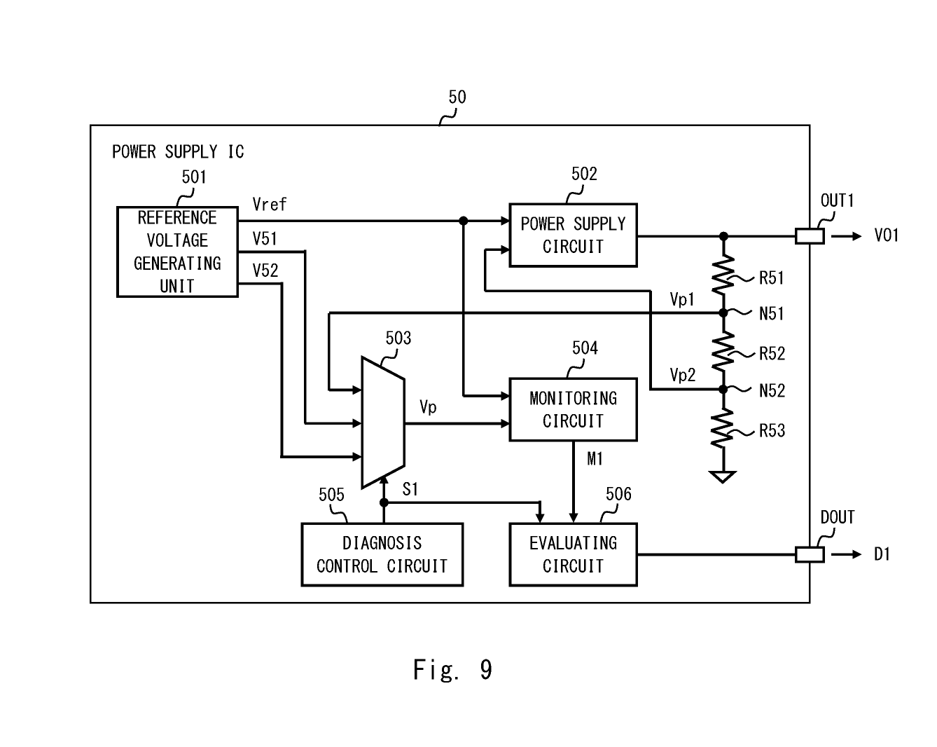

A power supply IC50 that has been previously examined by the present inventor will be described with reference to FIGS. 9, 10, and 11 before explaining details of the abovementioned power supply IC1 inside the electronic control system SYS1 mounted on the automobile.

FIG. 9 is a drawing showing a configuration example of a part of the power supply IC50 according to a concept before the embodiments were conceived. Note that in FIG. 9, only a power supply circuit 502 that outputs the power supply voltage VO1 is shown among the three power supply circuits that output the power supply voltages VO1 to VO3, respectively.

### (Configuration of Power Supply IC50)

As shown in FIG. 9, the power supply IC50 includes a reference voltage generating unit 501, the power supply circuit 502, a selection circuit 503, a monitoring circuit 504, a diagnosis control circuit 505, an evaluating circuit 506, and resistive elements R51 to R53. Note that the selection circuit 503 and the diagnosis control circuit 505 constitute a control unit.

The reference voltage generating unit 501 is, for example, a bandgap reference and generates a reference voltage Vref. Further, the reference voltage generating unit 501 generates a diagnosis voltage V51 that has a voltage value greater than that of the reference voltage Vref and a diagnosis voltage V52 that has a voltage value smaller than that of the reference voltage Vref. As an example, the reference voltage Vref is 1.2 V, the diagnosis voltage V51 is 1.3 V, and the diagnosis voltage V52 is 1.1 V in the following descriptions.

The power supply circuit 502 is, for example, a regulator and generates the power supply voltage VO1 based on the reference voltage Vref. Note that the power supply circuit 502 reduces fluctuations in the power supply voltage VO1 based on a voltage Vp2 that has been fed back. The power supply voltage VO1 is supplied to the microcomputer 104 (not shown in FIG. 9) provided outside the power supply IC50 via an external terminal OUT1. As an example, the power supply voltage VO1 at a normal time is 5.0 V in the following descriptions.

The resistive elements R51 to R53 are monitored voltage generating units that generate a monitored voltage Vp1 corresponding to the power supply voltage VO1. The resistive elements R51 to R53 are arranged in series between an output terminal of the power supply circuit 502 and a ground voltage terminal. The resistive elements R51 to R53 output a potential of a node N51 that is between the resistive elements R51 and R52 as the monitored voltage Vp1 and output a potential of a node N52 that is between the resistive elements R52 and R53 as the feedback voltage Vp2. Note that the resistance values of the resistive elements R51 to R53 are adjusted in such a way that the monitored voltage Vp1 when the power supply voltage VO1 is normal will indicate a voltage value greater than that of the reference voltage Vref.

The selection circuit 503 selects any one of the monitored voltage Vp1, the diagnosis voltage V51, and the diagnosis voltage V52 based on a control signal S1 from the diagnosis control circuit 505 and then outputs the selected voltage as a voltage Vp.

The monitoring circuit 504 monitors as to whether or not the power supply voltage VO1 is normal. To be more specific, the monitoring circuit 504 is, for example, a comparator (a comparison circuit) that monitors as to whether or not the output voltage Vp of the selection circuit 503 indicates a voltage value greater than or equal to the reference voltage Vref and then outputs a monitoring result (a comparison result) M1.

For example, when the output voltage Vp is greater than or equal to the reference voltage Vref, the monitoring circuit 504 outputs an H-level monitoring result M1, while when the output voltage Vp is smaller than the reference voltage Vref, the monitoring circuit 504 outputs an L-level monitoring result M1.

During a normal operation, the evaluating circuit 506 evaluates as to whether or not the power supply voltage VO1 is normal based on the monitoring result M1 of the monitoring circuit 504. During a failure diagnosis, the evaluating circuit 506 evaluates as to whether or not the monitoring circuit 504 has a failure based on the monitoring result M1 of the monitoring circuit 504.

To be more specific, the evaluating circuit 506 outputs the evaluation result D1 based on the monitoring result M1 of the monitoring circuit 504 and the control signal S1 of the diagnosis control circuit 505 (i.e., information of the voltage selected by the selection circuit 503). The evaluation result D1 is supplied to the microcomputer 104 (not shown in FIG. 9) provided outside the power supply IC50 via an external terminal DOUT.

For example, when the monitored voltage Vp1 is selected by the selection circuit 503, the evaluating circuit 506 outputs the monitoring result M1 as the evaluation result D1. When the diagnosis voltage V51 is selected by the selection circuit 503, the evaluating circuit 506 outputs the monitoring result M1 as the evaluation result D1. When the diagnosis voltage V52 is selected by the selection circuit 503, the evaluating circuit 506 logically inverts the monitoring result M1 and outputs the logically inverted monitoring result M1 as the evaluation result D1. Hereinafter, a case in which the diagnosis voltage V51 is selected by the selection circuit 503 may be referred to as a case when the diagnosis voltage V51 is selected. Further, a case in which the diagnosis voltage V52 is selected by the selection circuit 13 may be referred to as a case when the diagnosis voltage V52 is selected.

### (Operation of Power Supply IC50).

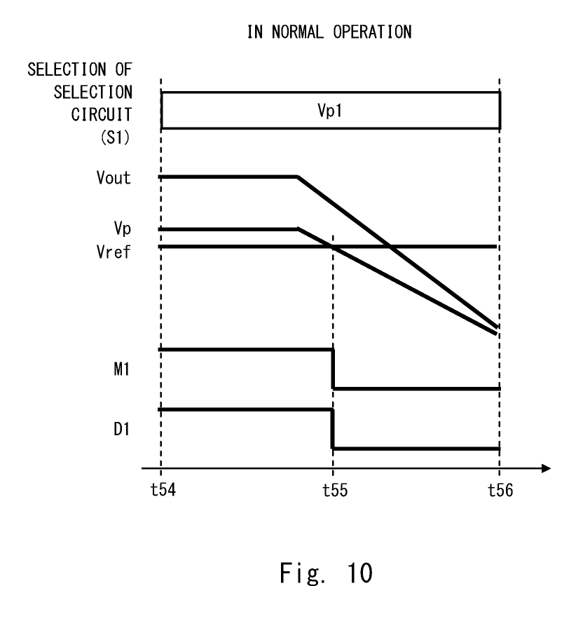

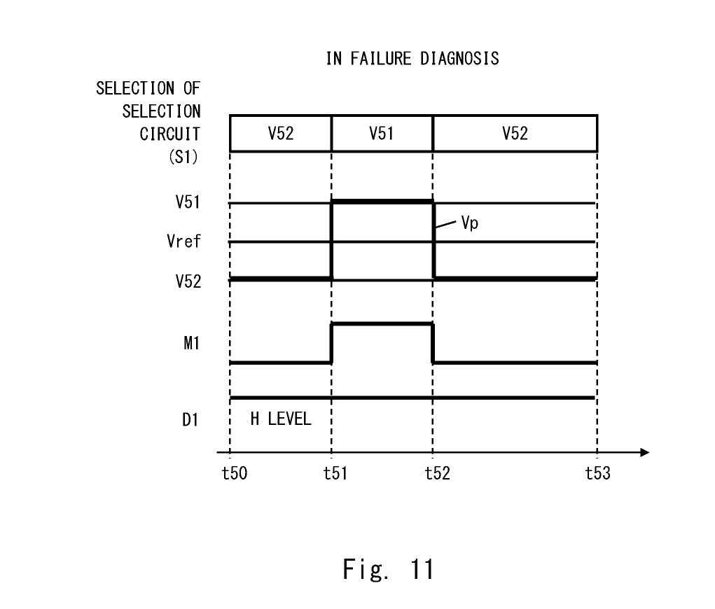

Next, an operation of the power supply IC50 will be described with reference to FIGS. 10 and 11. FIG. 10 is a timing chart showing the normal operation of the power supply IC50. FIG. 11 is a timing chart showing a failure diagnosis operation of the power supply IC50.

Firstly, in the normal operation shown in FIG. 10, the monitored voltage Vp1 is selected by the selection circuit 503. Therefore, the monitoring circuit 504 monitors as to whether or not the monitored voltage Vp1 (the voltage Vp) indicates a voltage value greater than or equal to that of the reference voltage Vref and then outputs the monitoring result M1. That is, the monitoring circuit 504 monitors as to whether or not the power supply voltage VO1 is normal and then outputs the monitoring result M1.

For example, when the power supply voltage VO1 is normal, as the monitored voltage Vp1 (the voltage Vp) indicates the voltage value greater than or equal to that of the reference voltage Vref, the monitoring circuit 504 outputs the H-level monitoring result M1 (from the time t54 to t55). At this time, as the evaluating circuit 506 outputs the monitoring result M1 as the evaluation result D1, the evaluating circuit 506 outputs the H-level evaluation result D1 (from the time t54 to t55). For example, the microcomputer 104 provided outside the power supply IC50 determines that the power supply voltage VO1 is normal based on the H-level evaluation result D1 in the normal operation.

On the other hand, when the power supply voltage VO1 becomes no longer normal due to a failure or the like in the power supply circuit 502, the monitored voltage Vp1 (the voltage Vp) is reduced along with a reduction in the power supply voltage VO1. Then, when the monitored voltage Vp1 is reduced to a voltage value that is smaller than that of the reference voltage Vref (at the time t55), the monitoring circuit 504 outputs the L-level monitoring result M1 that differs from an expected value (from the time t55 to t56). At this time, as the evaluating circuit 506 outputs the monitoring result M1 as the evaluation result D1, the evaluating circuit 506 outputs the L-level evaluation result D1 (from the time t55 to t56). For example, the microcomputer 104 provided outside the power supply IC50 determines that the power supply voltage VO1 is normal based on the L-level evaluation result D1 in the normal operation.

Next, in the failure diagnosis operation shown in FIG. 11, the selection circuit 503 alternately selects the diagnosis voltages V51 and V52 (at the times t50, t51, and t52). Accordingly, the monitoring circuit 504 alternately performs a comparison between the diagnosis voltage V51 and the reference voltage Vref and a comparison between the diagnosis voltage V52 and the reference voltage Vref.

If the voltage values of the diagnosis voltages V51 and V52 and the reference voltage Vref are V51, V52, and Vref, respectively, a relationship of V51>Vref>V52 is satisfied.

Accordingly, if the monitoring circuit 504 does not have a failure, the monitoring circuit 504 outputs the H-level monitoring result M1 when the diagnosis voltage V51 is selected (from the time t51 to t52) and outputs the L-level monitoring result M1 when the diagnosis voltage V52 is selected (from the time t50 to t51, and from the time t52 to t53).

At this time, as the evaluating circuit 506 outputs the monitoring result M1 as the evaluating result D1 when the diagnosis voltage V51 is selected or logically inverts the monitoring result M1 and then outputs the logically inverted monitoring result M1 as the evaluation result D1 when the diagnosis voltage V52 is selected, the evaluating circuit 506 continues to output the H-level evaluation result D1 as a result (from the time t50 to t53). For example, the microcomputer 104 provided outside the power supply IC50 determines that the monitoring circuit 504 does not have a failure based on the evaluation result D1 that is fixed to the H-level at the time of the failure diagnosis.

On the other hand, when the monitoring circuit 504 has a failure, the monitoring circuit 504 cannot output a correct monitoring result M1. Therefore, the monitoring circuit 504 outputs the L-level monitoring result M1 when the diagnosis voltage V51 is selected or outputs the H-level monitoring result M1 when the diagnosis voltage V52 is selected. At this time, the evaluating circuit 506 outputs the L-level evaluation result D1 in response to the monitoring result M1 with a voltage level that differs from an expected value. For example, the microcomputer 104 provided outside the power supply IC50 determines that the monitoring circuit 504 has a failure based on the L-level evaluation result D1 at the time of the failure diagnosis.

As described above, the power supply IC50 can perform the monitoring of the power supply voltage VO1 by the monitoring circuit 504 and the failure diagnosis of the monitoring circuit 504.

However, the normal operation by the monitoring circuit 504 (the monitoring of the power supply voltage VO1) and the failure diagnosis of the monitoring circuit 504 cannot be executed at the same time by the configuration of the power supply IC50. That is, when the monitoring circuit 504 normally operates, the failure diagnosis of the monitoring circuit 504 needs to be stopped, while when the failure diagnosis is performed on the monitoring circuit 504, the normal operation of the monitoring circuit 504 needs to be stopped. Thus, if the monitoring circuit 504 fails during the normal operation, the failure cannot be detected until the failure diagnosis is performed on the monitoring circuit 504 again. As a result, for example, the detection of the failure in the monitoring circuit could be delayed.

Hence, in order to be able to diagnose a failure in the monitoring circuit during the normal operation, the power supply IC1 according to this embodiment has been conceived.

(Power Supply IC1 According to this Embodiment)

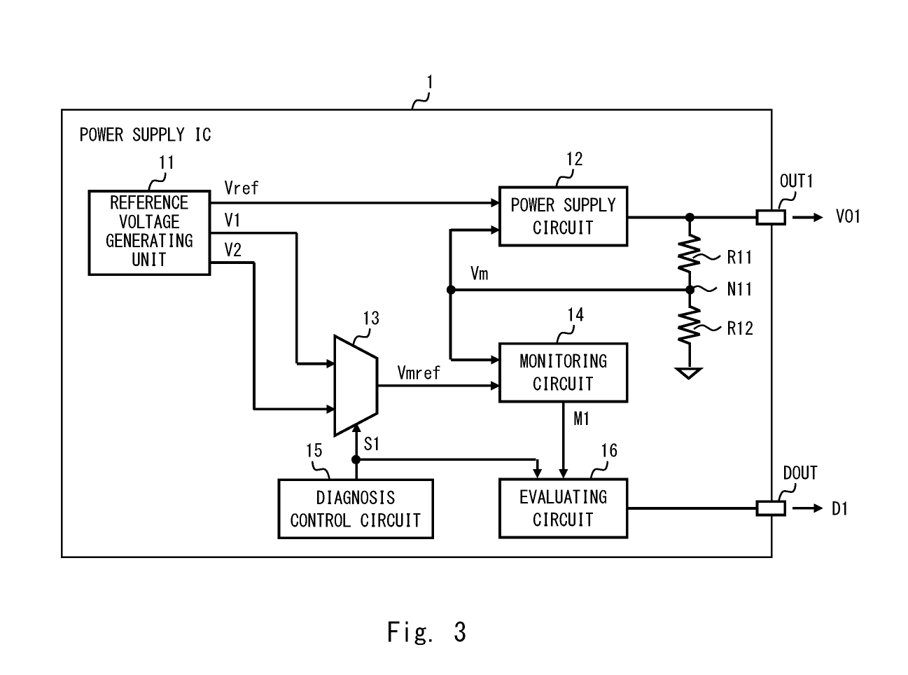

FIG. 3 is a drawing showing a specific configuration example of a part of the power supply IC1. Note that in FIG. 3, only a power supply circuit 12 that outputs the power supply voltage VO1 is shown among the three power supply circuits that output the power supply voltages VO1 to VO3, respectively.

### (Configuration of Power Supply IC1).

As shown in FIG. 3, the power supply circuit IC1 includes a reference voltage generating unit 11, the power supply circuit 12, a selection circuit 13, a monitoring circuit 14, a diagnosis control circuit 15, an evaluating circuit 16, and resistive elements R11 and R12. Note that the components provided in the power supply IC1 other than the reference voltage generating unit 11 and the power supply circuit 12 constitute a diagnosis circuit. Further, the selection circuit 13 and the diagnosis control circuit 15 constitute a control unit.

The reference voltage generating unit 11 is, for example, a bandgap reference and generates a reference voltage Vref. Further, the reference voltage generating unit 11 generates a reference voltage for monitoring V1 that has a voltage value greater than that of the reference voltage Vref and a reference voltage for monitoring V2 that has a voltage value smaller than that of the reference voltage Vref. As an example, the reference voltage Vref is 1.2 V, the monitored voltage Vm is 1.2 V, the reference voltage for monitoring V1 is 1.236 V, and the reference voltage for monitoring V2 is 1.164 V when the power supply voltage VO1 is normal in the following descriptions.

The power supply circuit 12 is, for example, a regulator and generates the power supply voltage VO1 based on the reference voltage Vref. Note that the power supply circuit 12 reduces fluctuations in the power supply voltage VO1 based on the voltage Vm that has been fed back. The power supply voltage VO1 is supplied to the microcomputer 104 (not shown in FIG. 3) provided outside the power supply IC1 via an external terminal OUT1. In this embodiment, as an example, the power supply voltage VO1 is 5.0 V at a normal time in the following descriptions.

The resistive elements R11 and R12 are monitored voltage generating units that generate the monitored voltage Vm corresponding to the power supply voltage VO1 and are arranged in series between an output terminal of the power supply circuit 12 and a ground voltage terminal. The resistive elements R11 and R12 output a potential of a node N11 that is between the resistive elements R11 and R12 as the monitored voltage Vm. Note that the resistance values of the resistive elements R11 and R12 are adjusted in such a way that the monitored voltage Vm when the power supply voltage VO1 is normal will indicate a voltage value smaller than that of the reference voltage for monitoring V1 and also greater than that of the reference voltage for monitoring V2.

The selection circuit 13 periodically switches between the reference voltages for monitoring V1 and V2 based on a control signal S1 from the diagnosis control circuit 15 and then outputs the switched voltage as a reference voltage for monitoring Vmref.

The monitoring circuit 14 monitors as to whether or not the power supply voltage VO1 is normal. To be more specific, the monitoring circuit 14 is, for example, a comparator (a comparison circuit) that compares the monitored voltage Vm with the output voltage Vmref of the selection circuit 13 and then outputs a monitoring result (a comparison result) M1.

For example, when the monitored voltage Vm is greater than or equal to the reference voltage for monitoring Vmref, the monitoring circuit 14 outputs an H-level monitoring result M1, while when the monitored voltage Vm is less than the reference voltage for monitoring Vmref, the monitoring circuit 14 outputs an L-level monitoring result M1.

The evaluating circuit 16 evaluates as to whether or not the power supply voltage VO1 is normal and whether or not the monitoring circuit 14 has a failure based on the monitoring result M1 of the monitoring circuit 14 and the control signal S1 of the diagnosis control circuit 15 (i.e., information of the voltage selected by the selection circuit 13) and then outputs the evaluation result D1. The evaluation result D1 is supplied to the microcomputer 104 (not shown in FIG. 3) provided outside the power supply IC1 via an external terminal DOUT.

For example, when the reference voltage for monitoring V2 is selected by the selection circuit 13, the evaluating circuit 16 outputs the monitoring result M1 as the evaluation result D1, while when the reference voltage for monitoring V1 is selected by the selection circuit 13, the evaluating circuit 16 logically inverts the monitoring result M1 and then outputs the logically inverted monitoring result M1 as the evaluation result D1. Hereinafter, a case in which the reference voltage for monitoring V1 is selected by the selection circuit 13 may be referred to as a case in which the reference voltage for monitoring V1 is selected. Further, a case in which the reference voltage for monitoring V2 is selected by the selection circuit 13 may be referred to as a case in which the reference voltage for monitoring V2 is selected.

### (Operation of Power Supply IC1)

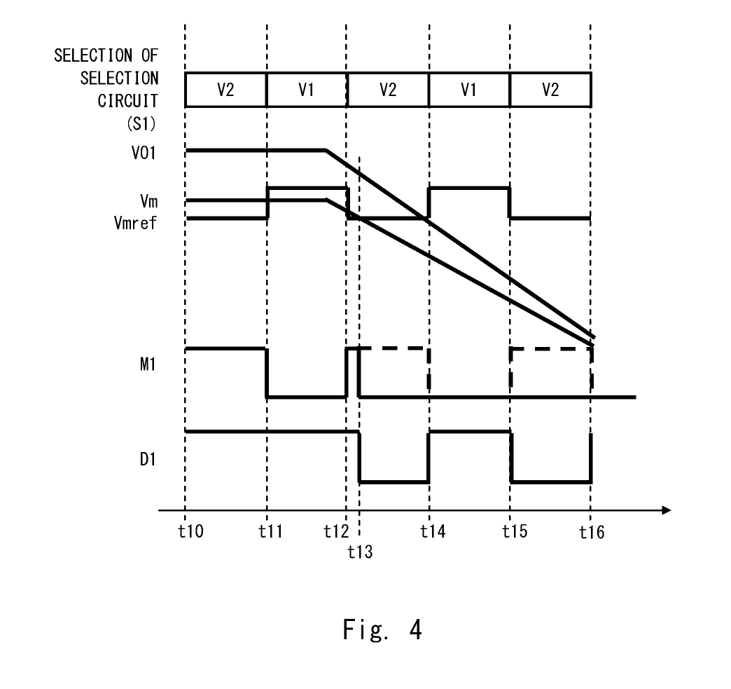

An operation of the power supply IC1 will be described with reference to FIG. 4. FIG. 4 is a timing chart showing the operation of the power supply IC1.

In the operation shown in FIG. 4, the reference voltages for monitoring V1 and V2 are alternately selected by the selection circuit 13 (at times t10, t11, t12, t14, and t15). Accordingly, the monitoring circuit 14 alternately performs a comparison between the monitored voltage Vm and the reference voltage for monitoring V1 and a comparison between the monitored voltage Vm and the reference voltage for monitoring V2.

If the voltage values of the reference voltages for monitoring V1 and V2 and the monitored voltage Vm at a normal time are V1, V2, and Vm, respectively, a relationship of V1>Vm>V2 is satisfied.

Therefore, if the monitoring circuit 14 does not have a failure and the power supply voltage VO1 is normal, the monitoring circuit 14 outputs the L-level monitoring result M1 when the reference voltage for monitoring V1 is selected, and the monitoring circuit 14 outputs the H-level monitoring result M1 when the reference voltage for monitoring V2 is selected (from the time t10 to t13). That is, the monitoring circuit 14 outputs the pulsed monitoring result M1 (from the time t10 to t13).

At this time, as the evaluating circuit 16 logically inverts the monitoring result M1 and then outputs the logically inverted monitoring result M1 as the evaluating result D1 when the reference voltage for monitoring V1 is selected and outputs the monitoring result M1 as the evaluation result D1 when the reference voltage for monitoring V2 is selected, the evaluating circuit 16 continues to output the H-level evaluation result D1 as a result (from the time t10 to t13).

In other words, when the value of the monitoring result M1 is changed according to the switching of the reference voltage for monitoring selected by the selection circuit 13, the evaluating circuit 16 determines that the power supply voltage VO1 is normal and the monitoring circuit 14 does not have a failure and then continues to output the H-level evaluation result D1 (from the time t10 to t13).

On the other hand, when the power supply voltage VO1 becomes no longer normal due to a failure or the like in the power supply circuit 12, the monitored voltage Vm is reduced along with a reduction in the power supply voltage Vol. Then, when the monitored voltage Vm is reduced to a voltage value that is smaller than that of the reference voltage for monitoring V2 (at the time t13), the monitoring circuit 14 outputs the L-level monitoring result M1 that differs from an expected value (the broken lines) when the reference voltage for monitoring V2 is selected (from the time t13 to t14 and from the time t15 to t16). Note that the monitoring circuit 14 continues to output the L-level monitoring result M1 when the reference voltage for monitoring V1 is selected (from the time t14 to t15). That is, the monitoring circuit 14 outputs the monitoring result M1 fixed to the L-level (from the time t13 to t16).

At this time, the evaluating circuit 16 outputs the L-level evaluation result D1 in response to the output of the L-level monitoring result M1 that differs from the expected value when the reference voltage for monitoring V2 is selected (from the time t13 to t14 and from the time t15 to t16). That is, the evaluating circuit 16 outputs the pulsed evaluation result D1 including an L level (from the time t13 to t16).

When the monitoring circuit 14 has a failure, regardless of whether or not the power supply voltage VO1 is normal, the monitoring circuit 14 cannot output a correct monitoring result M1. Therefore, the monitoring circuit 14 outputs the H-level monitoring result M1 when the reference voltage for monitoring V1 is selected or outputs the L-level monitoring result M1 when the reference voltage for monitoring V2 is selected. At this time, the evaluating circuit 16 outputs the L-level evaluation result D1 in response to the output of the monitoring result M1 with a voltage level that differs from the expected value.

In other words, when the value of the monitoring result M1 is not changed according to the switching of the reference voltage for monitoring selected by the selection circuit 13, the evaluating circuit 16 determines that the power supply voltage VO1 is abnormal or the monitoring circuit 14 has a failure and then outputs the evaluation result D1 including an L level (i.e., outputs the pulsed evaluation result D1).

As described above, the power supply IC1 and the diagnosis circuit provided in the power supply IC1 according to this embodiment include the selection circuit 13 that periodically switches between the reference voltage for monitoring V1 that has a voltage value greater than that of the monitored voltage Vm at a normal time and the reference voltage for monitoring V2 that has a voltage value smaller than that of the monitored voltage Vm at a normal time and then outputs the switched voltage, and the monitoring circuit 14 that compares the monitored voltage Vm with the output voltage Vmref of the selection circuit 13 and then outputs the monitoring result M1. When the value of the monitoring result M1 is changed according to the switching of the voltage selected by the selection circuit 13, the power supply IC1 and the diagnosis circuit provided in the power supply IC1 according to this embodiment determine that the power supply voltage VO1 is normal and the monitoring circuit 14 does not have a failure. When the value of the monitoring result M1 is not changed according to the switching of the voltage selected by the selection circuit 13, the power supply IC1 and the diagnosis circuit provided in the power supply IC1 according to this embodiment determine that the power supply voltage VO1 is abnormal or the monitoring circuit 14 has a failure.

It is thus possible for the power supply IC1 and the diagnosis circuit provided in the power supply IC1 according to this embodiment to perform the failure diagnosis on the monitoring circuit 14 during the normal operation. Accordingly, even when the monitoring circuit 14 has a failure during the normal operation, the failure can be promptly detected. Moreover, there is no need of a period in which the failure diagnosis is to be performed on the monitoring circuit 14 before the normal operation.

In this embodiment, although an example in which the reference voltage generating unit 11, the power supply circuit 12, and the diagnosis circuit are mounted on one chip (the power supply IC1) has been described, the present invention is not limited to this. It is obvious that the reference voltage generating unit 11, the power supply circuit 12, and the diagnosis circuit may be mounted on chips that are different from each other.

### (Specific Configuration of Power Supply IC1)

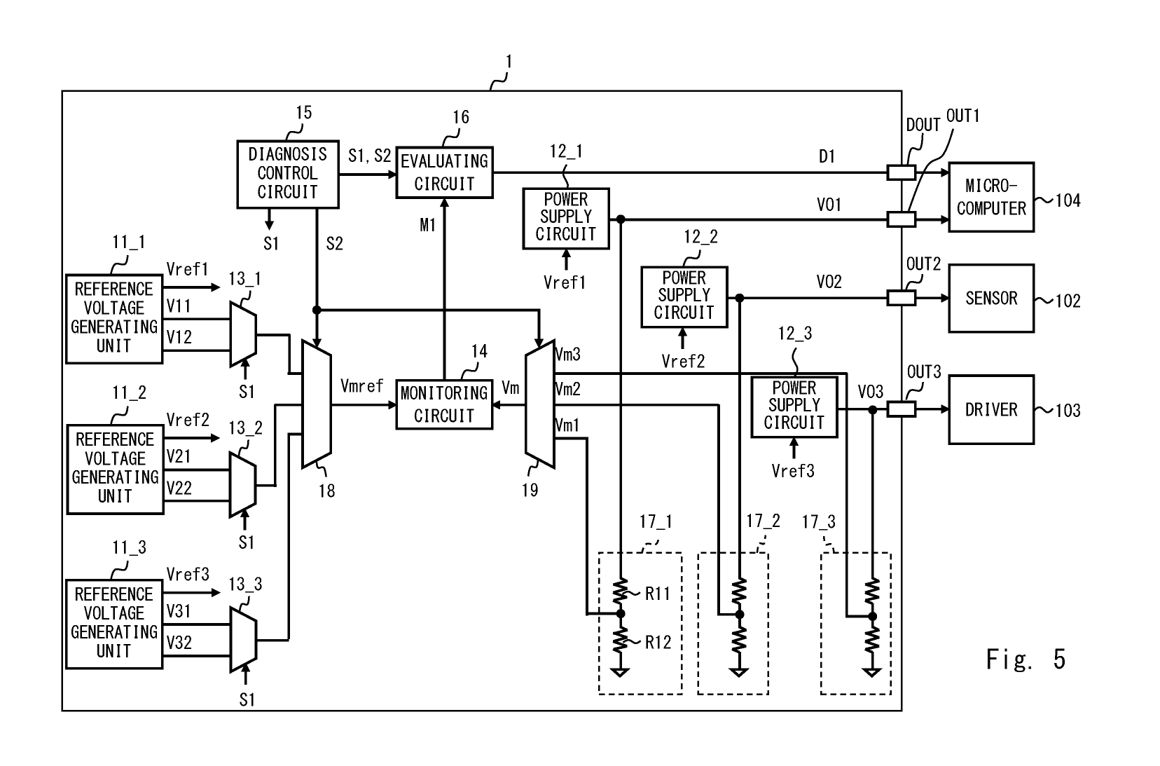

Hereinafter, a more specific configuration of the power supply IC1 will be described with reference to FIG. 5.

FIG. 5 is a drawing showing a specific configuration example of the power supply IC1. In FIG. 5, not only a power supply circuit 12_1 (corresponding to the power supply circuit 12) that outputs the power supply voltage VO1 but also two power supply circuits 12_2 and 12_3 that output power supply voltages VO2 and VO3, respectively, and peripheral circuits thereof are shown. Note that in FIG. 5, the sensor 102, the driver 103, and the microcomputer 104 that are provided outside the power supply IC1 are also shown.

In the power supply IC1 shown in FIG. 5, reference voltage generating units 11_1 to 11_3, power supply circuits 12_1 to 12_3, selection circuits 13_1 to 13_3, and monitored voltage generating units 17_1 to 17_3 are provided for the microcomputer 104, the sensor 102, and the driver 103, respectively. Moreover, the monitoring circuit 14, the diagnosis control circuit 15, the evaluating circuit 16, and the selection circuits 18 and 19 are shared by the microcomputer 104, the sensor 102, and the driver 103.

The power supply circuits 12_1 to 12_3 output the power supply voltages VO1 to VO3 based on reference voltages Vref1 to Vref3 from the reference voltage generating units 11_1 to 11_3, respectively. The power supply voltages VO1 to VO3 are supplied to the microcomputer 104, the sensor 102, and the driver 103 via external terminals OUT1 to OUTS, respectively.

The selection circuit 13_1 periodically switches between reference voltages for monitoring V11 and V12 output by the reference voltage generating unit 11_1 based on a control signal S1 from the diagnosis control circuit 15 and then outputs the switched voltage. The selection circuit 13_2 periodically switches between reference voltages for monitoring V21 and V22 output by the reference voltage generating unit 11_2 based on the control signal S1 and then outputs the switched voltage. The selection circuit 13_3 periodically switches between reference voltages for monitoring V31 and V32 output by the reference voltage generating unit 11_3 based on the control signal S1 and then outputs the switched voltage.

The monitored voltage generating units 17_1 to 17_3 are each composed of resistive elements R11 and R12 and output monitored voltages Vm1 to Vm3 corresponding to the power supply voltages VO1 to VO3, respectively.

The selection circuit 18 switches, in a time-sharing manner, between output voltages of the selection circuits 13_1 to 13_3 based on a control signal S2 from the diagnosis control circuit 15 and then outputs the switched voltage as the reference voltage for monitoring Vmref. The selection circuit 19 switches, in a time-sharing manner, between the monitored voltages Vm1 to Vm3 based on the control signal S2 from the diagnosis control circuit 15 and then outputs the switched voltage as the reference voltage for monitoring Vm. Note that a switching cycle of the selection by the selection circuits 18 and 19 is adjusted so that it will become long enough for the monitoring circuit 14 to monitor as to whether or not the power supply voltages VO1 to VO3 are normal.

The monitoring circuit 14 compares the output voltage Vm of the selection circuit 19 with the output voltage Vmref of the selection circuit 18 and then outputs the monitoring result M1. The evaluating circuit 16 sequentially evaluates as to whether or not the power supply voltages VO1 to VO3 are normal and whether or not the monitoring circuit 14 has a failure based on the monitoring result M1 and the control signals S1 and S2 (i.e., information of the voltages selected by the selection circuits 18 and 19) and then outputs the evaluation result D1. The evaluation result D1 is supplied to the microcomputer 104 provided outside the power supply IC1 via the external terminal DOUT. As the specific operations of the monitoring circuit 14, the diagnosis control circuit 15, and the evaluating circuit 16 have been described above, the descriptions thereof will be omitted.

As described above, the power supply IC1 shown in FIG. 5 monitors the power supply voltages VO1 to VO3 output by the plurality of power supply circuits 12_1 to 12_3, respectively, by using one monitoring circuit 14. Therefore, an increase in the circuit size and the current consumption can be prevented. Additionally, the power supply IC1 shown in FIG. 5 can perform failure diagnosis of the monitoring circuit 14 while monitoring the power supply voltages VO1 to VO3.

### Second Embodiment

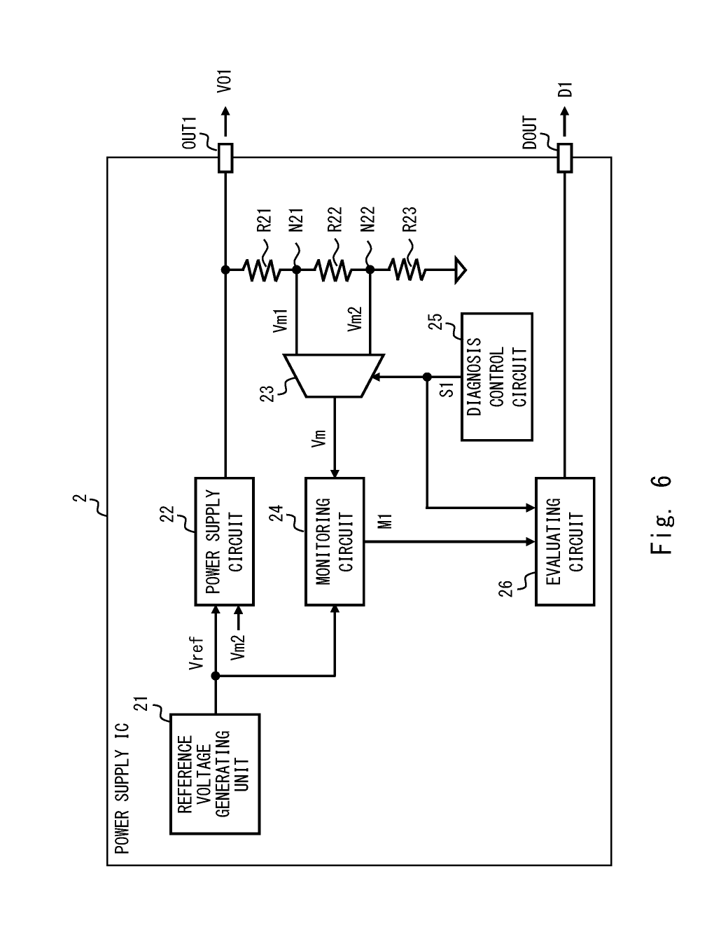

FIG. 6 is a drawing showing a configuration example of a power supply IC2 according to a second embodiment. As shown in FIG. 6, the power supply circuit IC2 includes a reference voltage generating unit 21, a power supply circuit 22, a selection circuit 23, a monitoring circuit 24, a diagnosis control circuit 25, an evaluating circuit 26, and resistive elements R21 to R23. Note that the components provided in the power supply IC2 other than the reference voltage generating unit 21 and the power supply circuit 22 constitute a diagnosis circuit. Further, the selection circuit 23 and the diagnosis control circuit 25 constitute a control unit.

Note that the reference voltage generating unit 21, the power supply circuit 22, the selection circuit 23, the monitoring circuit 24, the diagnosis control circuit 25, the evaluating circuit 26, and the resistive elements R21 to R23 correspond to reference voltage generating unit 11, the power supply circuit 12, the selection circuit 13, the monitoring circuit 14, the diagnosis control circuit 15, the evaluating circuit 16, and the resistive elements R11 and R12, respectively.

The reference voltage generating unit 21 is, for example, a bandgap reference and generates a reference voltage Vref. In this embodiment, as an example, the reference voltage Vref is 1.2 V, the monitored voltage Vm1 is 1.236 V when the power supply voltage VO1 is normal, and the monitored voltage Vm2 is 1.164 V when the power supply voltage VO1 is normal in the following descriptions.

The power supply circuit 22 is, for example, a regulator and generates the power supply voltage VO1 based on the reference voltage Vref. Note that the power supply circuit 12 reduces fluctuations in the power supply voltage VO1 based on the voltage Vm2 that has been fed back. The power supply voltage VO1 is supplied to a microcomputer 204 (not shown in FIG. 6) provided outside the power supply IC2 via an external terminal OUT1. In this embodiment, as an example, the power supply voltage VO1 is 5.0 V at a normal time in the following descriptions.

The resistive elements R21 to R23 are monitored voltage generating units that generate monitored voltages Vm1 and Vm2 corresponding to the power supply voltage VO1 and are arranged in series between an output terminal of the power supply circuit 22 and a ground voltage terminal. The resistive elements R21 to R23 output a potential of a node N21 that is between the resistive elements R21 and R22 as the monitored voltage Vm1 and output a potential of a node N22 that is between the resistive elements R22 and R23 as the monitored voltage Vm2. Note that the resistance values of the resistive elements R21 to R23 are adjusted in such a way that the monitored voltage Vm1 when the power supply voltage VO1 is normal will indicate a voltage value greater than that of the reference voltage Vref and the monitored voltage Vm2 when the power supply voltage VO1 is normal will indicate a voltage value smaller than that of the reference voltage Vref.

The selection circuit 23 periodically switches between the monitored voltage Vm1 and the monitored voltage Vm2 based on a control signal S1 from the diagnosis control circuit 25 and then outputs the switched voltage as the monitored voltage Vm.

The monitoring circuit 24 monitors as to whether or not the power supply voltage VO1 is normal. To be more specific, the monitoring circuit 24 is, for example, a comparator (a comparison circuit) that compares the output voltage Vm of the selection circuit 23 with the reference voltage Vref and then outputs a monitoring result (a comparison result) M1.

For example, when the monitored voltage Vm is greater than or equal to the reference voltage for monitoring Vref, the monitoring circuit 24 outputs an H-level monitoring result M1, while when the monitored voltage Vm is less than the reference voltage for monitoring Vref, the monitoring circuit 24 outputs an L-level monitoring result M1.

The evaluating circuit 26 evaluates as to whether or not the power supply voltage VO1 is normal and whether or not the monitoring circuit 24 has a failure based on the monitoring result M1 of the monitoring circuit 24 and the control signal S1 of the diagnosis control circuit 25 (i.e., information of the voltage selected by the selection circuit 23) and then outputs the evaluation result D1. The evaluation result D1 is supplied to the microcomputer 204 (not shown in FIG. 6) provided outside the power supply IC2 via the external terminal DOUT.

For example, when the monitored voltage Vm1 is selected by the selection circuit 23, the evaluating circuit 26 outputs the monitoring result M1 as the evaluation result D1, while when the monitored voltage Vm2 is selected by the selection circuit 23, the evaluating circuit 26 logically inverts the monitoring result M1 and then outputs the logically inverted monitoring result M1 as the evaluation result D1. Hereinafter, a case in which the monitored voltage Vm1 is selected by the selection circuit 23 may be referred to as a case in which the monitored voltage Vm1 is selected. Further, a case in which the monitored voltage Vm2 is selected by the selection circuit 23 may be referred to as a case in which the monitored voltage Vm2 is selected.

### (Operation of Power Supply IC2)

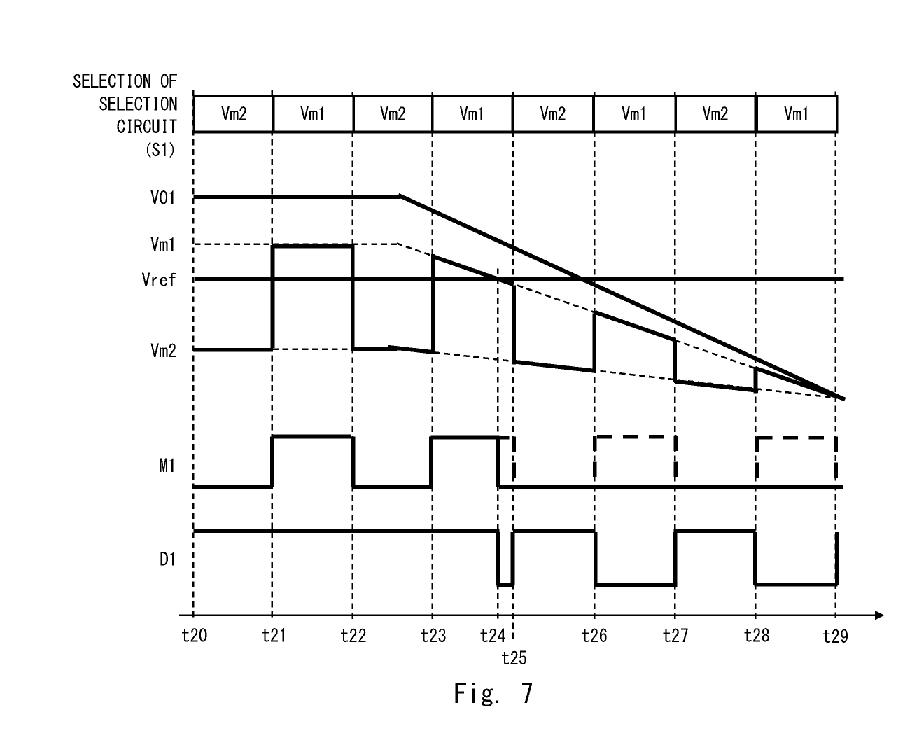

An operation of the power supply IC2 will be described with reference to FIG. 7. FIG. 7 is a timing chart showing the operation of the power supply IC2.

In the normal operation shown in FIG. 7, the selection circuit 23 alternately selects the monitored voltages Vm1 and Vm2 (at the times t20, t21, t22, t23, t24, t26, t27, and t28). Accordingly, the monitoring circuit 24 alternately performs comparison between the monitored voltage Vm1 and the reference voltage Vref and comparison between the monitored voltage Vm2 and the reference voltage Vref.

If the voltage values of the monitored voltages Vm1 and Vm2 at a normal time and the reference voltage Vref are Vm1, Vm2, and Vref, respectively, a relationship of Vm1>Vref>Vm2 is satisfied.

Therefore, if the monitoring circuit 24 does not have a failure and the power supply voltage VO1 is normal, the monitoring circuit 24 outputs the H-level monitoring result M1 when the monitored voltage Vm1 is selected, and the monitoring circuit 24 outputs the L-level monitoring result M1 when the monitored voltage Vm2 is selected (from the time t20 to t24). That is, the monitoring circuit 24 outputs the pulsed monitoring result M1 (from the time t20 to t24).

At this time, as the evaluating circuit 26 outputs the monitoring result M1 as the evaluating result D1 when the monitored voltage Vm1 is selected or logically inverts the monitoring result M1 and then outputs the logically inverted monitoring result M1 as the evaluation result D1 when the monitored voltage Vm2 is selected, the evaluating circuit 26 continues to output the H-level evaluation result D1 as a result (from the time t20 to t24).

In other words, when the value of the monitoring result M1 is changed according to the switching of the monitored voltage selected by the selection circuit 23, the evaluating circuit 26 determines that the power supply voltage VO1 is normal and the monitoring circuit 24 does not have a failure and then continues to output the H-level evaluation result D1 (from the time t20 to t24).

On the other hand, when the power supply voltage VO1 becomes no longer normal due to a failure or the like in the power supply circuit 22, the monitored voltage Vm1 is reduced along with a reduction in the power supply voltage Vol. Then, when the monitored voltage Vm1 is reduced to a voltage value that is smaller than that of the reference voltage Vref (at the time t24), the monitoring circuit 24 outputs the L-level monitoring result M1 that differs from an expected value (broken lines) when the monitored voltage Vm1 is selected (from the time t24 to t25, from the time t26 to t27, and from the time t28 to t29). Note that the monitoring circuit 24 continues to output the L-level monitoring result M1 when the monitored voltage Vm2 is selected (from the time t25 to t26 and from the time t27 to t28). That is, the monitoring circuit 24 outputs the monitoring result M1 fixed to the L-level (from the time t24 to t29).

At this time, the evaluating circuit 26 outputs the L-level evaluation result D1 in response to the output of the L-level monitoring result M1 that differs from the expected value when the monitored voltage Vm1 is selected (from the time t24 to t25, from the time t26 to t27, and from the time t28 to t29). That is, the evaluating circuit 26 outputs the pulsed evaluation result D1 including an L level (from the time t24 to t29).

When the monitoring circuit 24 has a failure, regardless of whether or not the power supply voltage VO1 is normal, the monitoring circuit 24 cannot output a correct monitoring result M1. Therefore, the monitoring circuit 24 outputs the L-level monitoring result M1 when the monitored voltage Vm1 is selected or outputs the H-level monitoring result M1 when the monitored voltage Vm2 is selected. At this time, the evaluating circuit 26 outputs the L-level evaluation result D1 in response to the output of the monitoring result M1 with a voltage level that differs from the expected value. That is, the evaluating circuit 26 outputs the pulsed evaluation result D1 including an L level.

In other words, when the value of the monitoring result M1 is not changed according to the switching of the monitored voltage selected by the selection circuit 23, the evaluating circuit 26 determines that the power supply voltage VO1 is abnormal or the monitoring circuit 24 has a failure and then outputs the evaluation result D1 including an L level (i.e., outputs the pulsed evaluation result D1).

As described above, the power supply IC2 and the diagnosis circuit provided in the power supply IC2 according to this embodiment include the selection circuit 23 that periodically switches between the monitored voltage Vm1 that has a voltage value greater than that of the reference voltage Vref at a normal time and the monitored voltage Vm2 that has a voltage value smaller than that of the reference voltage Vref at a normal time and then outputs the switched voltage, and the monitoring circuit 24 that compares the output voltage Vm of the selection circuit 23 with the reference voltage Vref and then outputs the monitoring result M1. When the value of the monitoring result M1 is changed according to the switching of the voltage selected by the selection circuit 23, the power supply IC2 and the diagnosis circuit provided in the power supply IC2 according to this embodiment determine that the power supply voltage VO1 is normal and the monitoring circuit 24 does not have a failure. When the value of the monitoring result M1 is not changed according to the switching of the voltage selected by the selection circuit 23, the power supply IC2 and the diagnosis circuit provided in the power supply IC2 according to this embodiment determine that the power supply voltage VO1 is abnormal or the monitoring circuit 24 has a failure.

It is thus possible for the power supply IC2 and the diagnosis circuit provided in the power supply IC2 according to this embodiment to perform the failure diagnosis on the monitoring circuit 24 during the normal operation. Accordingly, even when the monitoring circuit 24 has a failure during the normal operation, the failure can be promptly detected. Moreover, there is no need of a period in which the failure diagnosis is to be performed on the monitoring circuit 24 before the normal operation.

In this embodiment, although an example in which the reference voltage generating unit 21, the power supply circuit 22, and the diagnosis circuit are mounted on one chip (the power supply IC2) has been described, the present invention is not limited to this. It is obvious that the reference voltage generating unit 21, the power supply circuit 22, and the diagnosis circuit may be mounted on chips that are different from each other.

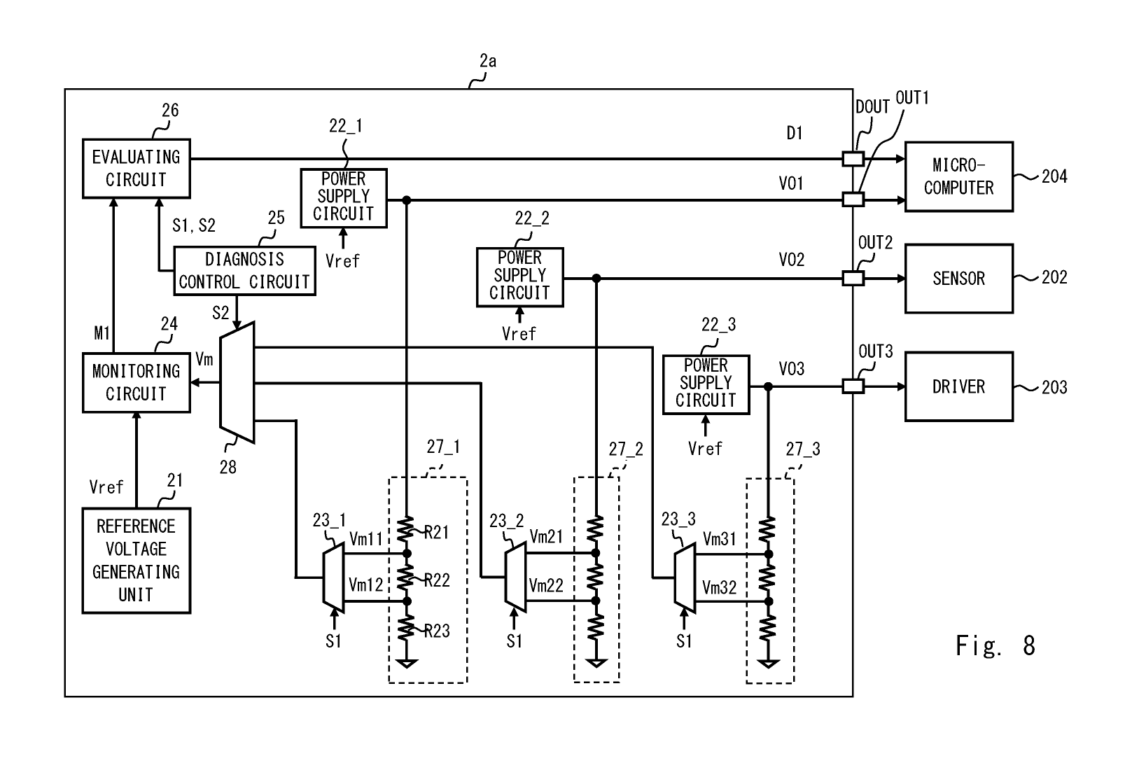

Further, in this embodiment, although an example in which one power supply circuit 22 is provided on the power supply IC2 has been described, the present invention is not limited to this. A plurality of power supply circuits may be provided on the power supply IC2. Hereinafter, such a case will be described in detail with reference to FIG. 8.

### (Modified Example of Power Supply IC2)

FIG. 8 is a drawing showing a power supply IC2a that is a modified example of the power supply IC2. In the power supply IC2a, not only a power supply circuit 22_1 (corresponding to the power supply circuit 22) that outputs the power supply voltage VO1 but also two power supply circuits 22_2 and 22_3 that output the power supply voltages VO2 and VO3, respectively, and peripheral circuits thereof are shown. Note that in FIG. 8, a sensor 202, a driver 203, and a microcomputer 204 that are provided outside the power supply IC2a are also shown.

In the power supply IC2a shown in FIG. 8, power supply circuits 22_1 to 22_3, selection circuits 23_1 to 23_3, and monitored voltage generating units 27_1 to 27_3 are provided for the microcomputer 204, the sensor 202, and the driver 203, respectively. Moreover, the reference voltage generating unit 21, the monitoring circuit 24, the diagnosis control circuit 25, the evaluating circuit 26, and the selection circuit 28 are shared by the microcomputer 204, the sensor 202, and the driver 203.

The power supply circuits 22_1 to 22_3 output the power supply voltages VO1 to VO3 based on the reference voltage Vref from the common reference voltage generating unit 21. The power supply voltages VO1 to VO3 are supplied to the microcomputer 204, the sensor 202, and the driver 203 via external terminals OUT1 to OUTS, respectively.

The monitored voltage generating units 27_1 to 27_3 are each composed of resistive elements R21 to R23 and output monitored voltages Vm11, Vm12 to Vm31, and Vm32, respectively.

The selection circuit 23_1 periodically switches between the monitored voltages Vm11 and Vm12 output by the monitored voltage generating unit 27_1 based on a control signal S1 from the diagnosis control circuit 25 and then outputs the switched voltage. The selection circuit 23_2 periodically switches between the monitored voltages Vm21 and Vm22 output by the monitored voltage generating unit 27_2 based on the control signal S1 and then outputs the switched voltage. The selection circuit 23_3 periodically switches between the monitored voltages Vm31 and Vm32 output by the monitored voltage generating unit 27_3 based on the control signal S1 and then outputs the switched voltage.

The selection circuit 28 switches, in a time-sharing manner, between the output voltages of the selection circuits 23_1 to 23_3 based on a control signal S2 from the diagnosis control circuit 25 and then outputs the switched voltage as the monitored voltage Vm. Note that a switching cycle of the selection by the selection circuit 28 is adjusted so that it will become long enough for the monitoring circuit 24 to check as to whether or not the power supply voltages VO1 to VO3 are normal.

The monitoring circuit 24 compares the output voltage Vm of the selection circuit 28 with the reference voltage Vref and then outputs the monitoring result M1. The evaluating circuit 26 sequentially evaluates as to whether or not the power supply voltages VO1 to VO3 are normal and whether or not the monitoring circuit 24 has a failure based on the monitoring result M1 and the control signals S1 and S2 (i.e., information of the voltage selected by the selection circuit 28) and then outputs the evaluation result D1. The evaluation result D1 is supplied to the microcomputer 204 provided outside the power supply IC2a via the external terminal DOUT. As the specific operations of the monitoring circuit 24, the diagnosis control circuit 25, and the evaluating circuit 26 have been described above, the descriptions thereof will be omitted.

As described above, the power supply IC2a monitors the power supply voltages VO1 to VO3 output by the plurality of power supply circuits 22_1 to 22_3, respectively, by using one monitoring circuit 24. Therefore, an increase in the circuit size and the current consumption can be prevented. The common reference voltage Vref may be supplied to the monitoring circuit 24 even after the monitored voltage is switched. That is, one reference voltage generating unit 21 may be provided on the power supply IC2a. Therefore, an increase in the circuit size and the current consumption can be further prevented. Additionally, the power supply IC2a can perform failure diagnosis of the monitoring circuit 24 while monitoring the power supply voltages VO1 to VO3.

As described above, the power supply ICs and the diagnosis circuits provided therein according to the first and second embodiments include the selection unit that periodically switches one of the monitored voltage Vm and the reference voltage for monitoring Vmref to one of first and second voltage values in such a way that a magnitude relationship between the voltage value of the monitored voltage Vm and the voltage value of the reference voltage for monitoring Vmref (including the reference voltage Vref) is periodically switched; and the comparison circuit that compares the monitored voltage Vm with the reference voltage for monitoring Vmref.

When the comparison result (the monitoring result M1) is changed according to the switching of the voltage selected by the selection circuit, the power supply ICs and the diagnosis circuits provided therein according to the first and second embodiments determine that the power supply voltages are normal and the monitoring circuits do not have a failure, respectively. When the comparison results (the monitoring results M1) are not changed according to the switching of the voltages selected by the selection circuits, the power supply ICs and the diagnosis circuits provided therein according to the first and second embodiments determine that the power supply voltages are abnormal or the monitoring circuits have a failure, respectively.

It is thus possible for the power supply ICs and the diagnosis circuits provided therein according to the above first and second embodiments to perform the failure diagnosis on the monitoring circuit during the normal operation. Accordingly, even when the monitoring circuits have a failure during the normal operation, the failure can be promptly detected. Moreover, there is no need of a period in which the failure diagnosis is to be performed on the monitoring circuit before the normal operation.

Although an example in which the electronic control systems including the power supply IC1 and IC2 are mounted on automobiles, respectively, has been described in the first and second embodiments, the present invention is not limited to this and such an electronic control system may be mounted on other devices.

Although the invention carried out by the present inventor has been described based on the embodiments, it is obvious that the present invention is not limited to the above-described embodiments and various modifications can be made without departing from the scope of the invention.

For example, the conductive type (p-type or n-type) of a semiconductor substrate, a semiconductor layer, and a diffusion layer (diffusion region) etc. may be inverted in the semiconductor devices according to the above embodiments. Therefore, when one of the conductive types of n-type and p-type is referred to as a first conductive type, and the other one of the conductive types of n-type and p-type is referred to as a second conductive type, the first conductive type may be p-type, and the second conductive type may be n-type. Alternatively, the first conductive type may be n-type, and the second conductive type may be p-type.

The first and second embodiments can be combined as desirable by one of ordinary skill in the art.

While the invention has been described in terms of several embodiments, those skilled in the art will recognize that the invention can be practiced with various modifications within the spirit and scope of the appended claims and the invention is not limited to the examples described above.

Further, the scope of the claims is not limited by the embodiments described above.

Furthermore, it is noted that, Applicant's intent is to encompass equivalents of all claim elements, even if amended later during prosecution.

What is claimed is:

1. A diagnosis circuit comprising:
a control unit configured to periodically switch one of a monitored voltage and a reference voltage for monitoring to one of a first voltage value and a second voltage value in such a way that a magnitude relationship between a voltage value of the monitored voltage and a voltage value of the reference voltage for monitoring is periodically switched, the monitored voltage corresponding to a power supply voltage when the power supply voltage output by a power supply circuit is normal based on a reference voltage, and the reference voltage for monitoring corresponding to the reference voltage;
a comparison circuit configured to compare the monitored voltage with the reference voltage for monitoring; and
an evaluating circuit configured to evaluate as to whether or not the power supply voltage is normal and whether or not the comparison circuit has a failure based on a result of the comparison by the comparison circuit and information on the voltage value, which has been periodically switched by the control unit, of just one of the monitored voltage and the reference voltage for monitoring.

2. The diagnosis circuit according to claim 1, wherein when the result of the comparison by the comparison circuit is changed according to the periodical switching of the voltage value switched by the control unit, the evaluating circuit determines that the power supply voltage is normal and the comparison circuit has no failure, while when the result of the comparison by the comparison circuit is not changed according to the periodical switching of the voltage value switched by the control unit, the evaluating circuit determines that the power supply voltage is abnormal or the comparison circuit has a failure.

3. The diagnosis circuit according to claim 1, wherein the control unit comprises a selection circuit configured to periodically switch between a first reference voltage for monitoring and a second reference voltage for monitoring and then output a switched voltage as the reference voltage for monitoring, the first reference voltage for monitoring indicating the first voltage value greater than that of the monitored voltage when the power supply voltage is normal, and the second reference voltage for monitoring indicating the second voltage value smaller than that of the monitored voltage when the power supply voltage is normal.

4. The diagnosis circuit according to claim 1, wherein the control unit comprises a selection circuit configured to periodically switch between a first monitored voltage and a second monitored voltage and then output a switched voltage as the monitored voltage, the first monitored voltage being proportional to the power supply voltage and indicating the first voltage value greater than that of the reference voltage when the power supply voltage is normal, and the second monitored voltage being proportional to the power supply voltage and indicating the second voltage value smaller than that of the reference voltage when the power supply voltage is normal.

5. A semiconductor device comprising:
the diagnosis circuit according to claim 1;
a reference voltage generating unit configured to generate the reference voltage; and
the power supply circuit.

6. An on-vehicle electronic control unit comprising:
the diagnosis circuit according to claim 1;
a reference voltage generating unit configured to generate the reference voltage;
the power supply circuit configured to output the power supply voltage; and
a processing unit configured to be driven by the power supply voltage and give an instruction to a driver based on information from a sensor.

7. A diagnosis method of a diagnosis circuit comprising:
periodically switching one of a monitored voltage and a reference voltage for monitoring to one of a first voltage value and a second voltage value in such a way that a magnitude relationship between a voltage value of the monitored voltage and a voltage value of the reference voltage for monitoring is periodically switched, the monitored voltage corresponding to a power supply voltage when the power supply voltage output by a power supply circuit is normal based on a reference voltage, and the reference voltage for monitoring corresponding to the reference voltage;
comparing the monitored voltage with the reference voltage for monitoring by a comparison circuit; and
evaluating as to whether or not the power supply voltage is normal and whether or not the comparison circuit has a failure based on a result of the comparison by the comparison circuit and information on the voltage value, which has been periodically switched, of just one of the monitored voltage and the reference voltage for monitoring.

8. The diagnosis method of the diagnosis circuit according to claim 7, wherein
in the evaluation,
when the result of the comparison is changed according to the periodical switching of one of the voltage value of the monitored voltage and the voltage value of the reference voltage for monitoring, the power supply voltage is determined to be normal and the comparison circuit is determined to include no failure, and
when the result of the comparison is not changed according to the periodical switching of one of the voltage value of the monitored voltage and the voltage value of the reference voltage for monitoring, the power supply voltage is determined to be abnormal or the comparison circuit is determined to include a failure.

9. The diagnosis method of the diagnosis circuit according to claim 7, wherein
in the periodical switching of one of the voltage value of the monitored voltage and the voltage value of the reference voltage for monitoring to one of the first voltage value and the second voltage value, a first reference voltage for monitoring indicating the first voltage value greater than that of the monitored voltage when the power supply voltage is normal and a second reference voltage for monitoring indicating the second voltage value smaller than that of the monitored voltage when the power supply voltage is normal are periodically switched and then a switched voltage is output as the reference voltage for monitoring.

10. The diagnosis method of the diagnosis circuit according to claim 7, wherein
in the periodical switching of one of the voltage value of the monitored voltage and the voltage value of the reference voltage for monitoring to one of the first voltage value and the second voltage value, a first monitored voltage being proportional to the power supply voltage and indicating the first voltage value greater than the reference voltage when the power supply voltage is normal and a second monitored voltage being proportional to the power supply voltage and indicating the second voltage value smaller than that of the reference voltage when the power supply voltage is normal are periodically switched and then a switched voltage is output as the monitored voltage.
